(19) United States
(12) Patent Application Publication
(10) Pub. No.: US 2024/0169422 A1
(43) Pub. Date: May 23, 2024

(54) CH'S SERVICE PROVIDER Bitcoin paper Bills "New market currency idea"

(71) Applicant: Corey L Harris Sr, Erie, PA (US)

(72) Inventor: Corey L Harris Sr, Erie, PA (US)

(21) Appl. No.: 17/989,969

(22) Filed: Nov. 18, 2022

(51) Int. Cl. G06Q 40/02

(52) U.S. Cl. CPC G06Q 40/02

(57) ABSTRACT

A novel form of systems and method provided herein, a tool for managing and processing funds redistribution. The system involves new market currency approach which in accordance with block chain technology, banking systems and rules and regulations will help to lower the poverty across the world to 90%.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

The invention embodiments described herein generally relate to processing funds and related data within a computer system architecture. In various embodiments, the invention more particularly relates to various computer-implemented tools for managing and processing funds redistribution among people across the globe, which will act as a funds management tool and will provide further convenience, cost beneficial, easy workflow, and satisfaction for the user without compromising the original functionality required.

### Description of the Related Art

Economic inequality, whether measured through the gaps in income or wealth between richer and poorer households, continues to widen. The rise in economic inequality in the U.S. is tied to several factors. These include, in no particular order, technological change, globalization, the decline of unions, and the eroding value of the minimum wage. One reason for the concern is that people in the lower rungs of the economic ladder may experience diminished economic opportunity and mobility in the face of rising inequality, a phenomenon referred to as ‘The Great Gatsby Curve’. The poorest members of society suffer immediately from inequality, but in the longer term, the whole economy is also damaged. To reduce inequality, we must promote inclusive growth. Create economies where every citizen, regardless of income, wealth, gender, race, or origin is empowered to succeed.

It is required to create a process for providing equal opportunity and accessible funds to users equally. The basic requirement is to design a system to open the money flow from those who have money to those who need money. Along with many formal government-controlled schemes, there are several informal funds collection club arrangement schemes in the society. The informal fund collection arrangements more often than not work on a basic principle. Each member of the group makes a standard contribution to a common fund once per time period. Then each period the total contributions are disbursed to a single member of the group. The recipient changes each period in a rotating fashion such that all the members of the group are eventually recipients.

Some classic pre-existing informal fund collection arrangements are sou-sou, queue concept, charitable funds, other public welfare schemes. By looking at prior art multiple types of systems and processes have been proposed. For instance, apparatuses, methods and systems for a donation-coordinating electronic market platform bearing US patent 2,009,0192873A1 is issued to John Joseph Marble. The present disclosure details apparatuses, methods, and systems for a donation-coordinating electronic market platform that coordinates interactions and transactions between platform participants to facilitate the allocation of charitable donations based on consumer purchases. The platform sits at the intersection between charitable giving and retail transacting that is enabled by web-tools, search technology and electronic transaction processing. As such many new relationships are formed by the creation of a new set of technology links and functionality. The platform is configurable to collect, maintain, and update profile information for all participating entities; to link sales, marketing, advertising, and financial settlement; to track and report on consumer purchases, charitable donations, and advertising efficacy; and to build consumer loyalty while fostering a donation momentum that streamlines and maximizes the impact of charitable giving across market sectors.

Another patent on systems and methods for management of fundraising campaigns bearing U.S. Pat. No. 10,198,733B2 is issued to BLASS ALEXANDER. The present invention pertains to systems and methods for managing, creating, and conducting online personal fundraising campaigns. An exemplary embodiment of the present invention sets forth a system, method and computer program product for creating and managing online personal fundraising campaigns. In an exemplary embodiment, the method may include, e.g., but not limited to, receiving a request to establish a personal fundraising campaign from an initiator for benefit of a beneficiary at a central controller; receiving a plurality of donations at the controller; and disbursing at least a portion of the funds to the beneficiary.

A Gaming system for facilitating competition between fundraising campaigns bearing US patent 2,015,0161685A1 is issued to Change Up Inc. The patent relates to a computer-implemented method for providing a social media-based game for competing fundraising campaigns. More specifically, the method allows a user to round up a purchase to the nearest dollar or other amount and then contribute that change to a pool of donations, and further allows fundraising campaigns to compete for the pool of donations through various competitive, social media-based games. In some embodiments, the present invention may be incorporated directly within a digital wallet on a mobile device. In other embodiments the present invention may be a stand-alone application on a mobile device that interfaces with a digital wallet.

Another patent on Facilitating charitable donations on a banking system bearing U.S. Pat. No. 9,754,294B2 is issued to Mastercard International Inc. The system relates to methods, apparatus and systems for automatically calculating charitable donations for donors and for distributing the charitable donations in accordance with the donors' wishes to approved and/or registered recipients, such as approved charitable organizations. In some embodiments, the method includes receiving contributor information, recipient information and donation data during a predetermined period of time, and then aggregating the donations from a plurality of contributors into a plurality of recipient contribution amounts. The process also includes distributing, at the end of the predetermined period of time, the recipient contribution amounts to recipient financial institutions based on the contributor information, the recipient information and the donation data.

A WO patent 2,016,123461A1 on Systems, media, and methods for making charitable donations based on user configured events is issued to Brett Sean JACOBSON. The patent relates to applications for automatically transacting charitable donations triggered by location-based events and activities. The applications aggregate triggered donations and conduct a financial transaction when the aggregate amount meets or exceeds a predetermined threshold. The applications also generate an audible notification to the user and others nearby when each donation is triggered.

Another Electronic Coupon Fund Raising Program bearing US patent 2,019,0005526A1A plurality of databases contain data regarding merchants, charities and consumers is issued to Alexander S. Ewell Timothy V. Ewell. The patent relates to a network and server system enable consumers to donate funds to charities. Upon making a donation, a consumer is awarded system points or system credits that may be used to purchase goods and services from enrolled merchants. Upon entry into an enrolled merchant store, a consumer may select an item and then be presented with a discount amount in reaction to the consumer's previous donations made through the system. A system discount may be authenticated by use of a system generated discount code. Disclosed embodiments include means and methods of allowing consumers to leave comments and ratings to enrolled merchants.

A WO patent 2,018,237359A1 on systems and methods for managing fundraising activities is issued to Jeff KLIEWER William F. KLIEWER. The patent implies systems and methods for managing fundraising and donors through an interactive platform are provided to allow fundraiser organizers to manage donations, donor profiles and other fundraising analytics, while also creating donor-specific content delivered directly to specific segments of donors using a prioritized hierarchical communication system in order to increase engagement and retention of donors. Donors are provided with a customized content platform via an interactive feed, with additional options for creating customized donations to various fundraisers and selecting their own communication hierarchy for receiving content via multiple types of electronic communications, including text, e-mail, application and device notifications, etc. Fundraiser organizers can create dynamically-updated segments of donors based on donor profiles and donor activity such as recency, frequency and amount of donations made.

Another US patent 2,007,0063020A1 on system and method for charity gift card is issued to Capital One Financial Corp. The systems and methods enable the provision, management and use of a monetary card for making donations. A processor may cause information associated with donation parameters to be stored on a monetary card. The card may be given as a gift to a recipient. The recipient may use the card to make a donation to a donation recipient. The donation may be made by way of any suitable method or configuration. In one example scenario, the donation is made by the card recipient using a web-based communication system to specify one or more values associated with the donation parameters. For example, the card recipient may use the card to access an account or record and may select a donation recipient from among a list of available donation recipients and may also specify an amount to be donated. The donation may be linked to a separate financial account which may be held, for instance, by the purchaser of the card. The separate financial account may be debited when the card is first purchased, or when a donation is actually made by the card recipient.

There are multiple solutions that have been presented in prior art. However, these solutions are limited and restricted to their conventional architecture, installation system and have considerable shortcomings which adversely affect the convenience with which they can be used. Nevertheless, regardless of multiple types of novel solutions in this sector are presented, society is in constant requirement of an efficient computer implement process to receive funds and redistribute it to the users thus achieving the objective of funds redistribution from users to users. The known methods lack transparency and are often carry pre-existing flaws in their process of distributing funds. As for the instance, in the sou-sou method, the funds received by the user does not have any incremental effect. The charitable efforts and public welfare schemes are too much dependent either on the state or rich users to contribute with limited incentives. Additionally, in today's digital era it is highly required that the interaction of outside world is established with computer-implemented tools and techniques for easy, fast, and reliable processing. The user must have an option to view, process, contribute to the schemes remotely and ensuring transparency is thoroughly maintained. Furthermore, the prior systems have certain limitations including the design of assemblies which make them not suitable for every type of user. Moreover, the ease-of-use ability of these assemblies is also questionable.

This long felt unresolved need is solved by the present invention. It provides a new market approach where the gold donation deposits will be donated and supplied by international gifts will help to fight poverty. These gifts will be controlled and administered by company's service provider crypto platform and will perform the management.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary objective of this invention is to provide improvements in the method of managing and processing funds redistribution, and the like.

Another objective of the invention is to provide a computer-implemented tools for managing and processing funds redistribution for effecting online financial transactions.

Another objective of the invention is to provide a system where the M1 and M2 dollar currency will be used for goods and services and supported by banks.

It is also the objective of invention to provide a computer-implemented tool in connection with a processing unit and server to process the fund's redistribution and maintain a user profile database for robust and transparent functioning.

It is also the objective of invention to provide multiple functionalities to user including but not limited to easy profile creation, pre-defined categories, easy funds transfer and rewards management system.

It is also the objective of system to provide saving and corporate bonds facility.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

FIG. 1 illustrates a $1 bill in accordance with an embodiment of the present disclosure;

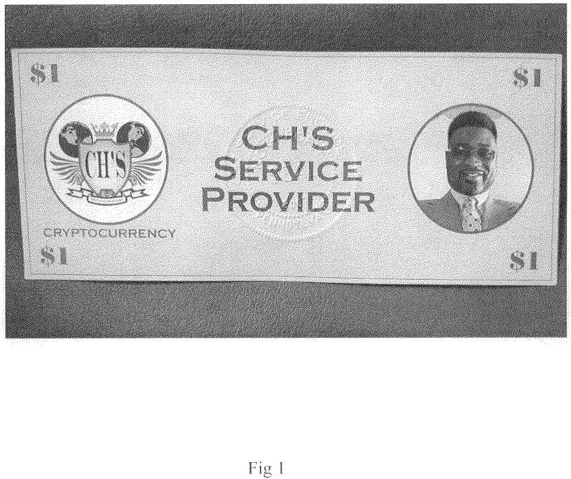

FIG. 2 illustrates a $10 bill in accordance with an embodiment of the present disclosure;

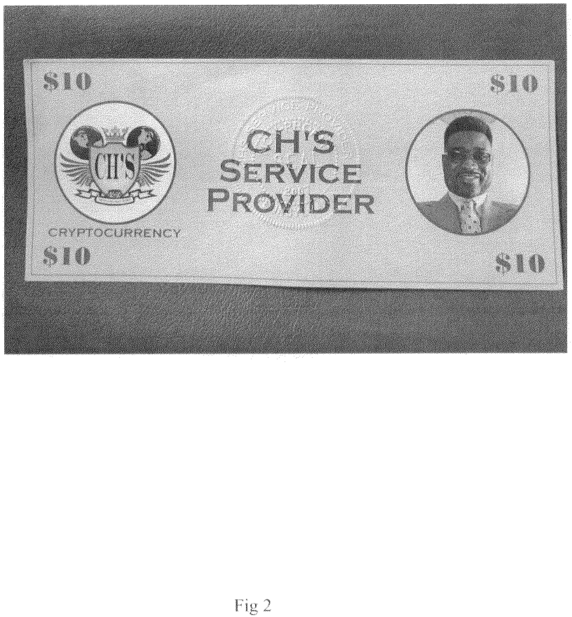

FIG. 3 illustrates a view of bill in accordance with an embodiment of the present disclosure;

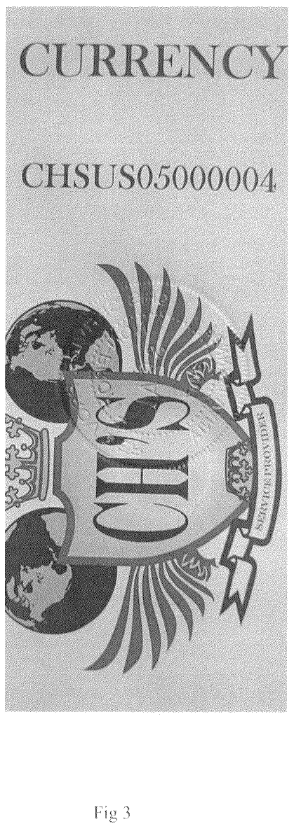

FIG. 4 illustrates a $20 bill in accordance with an embodiment of the present disclosure;

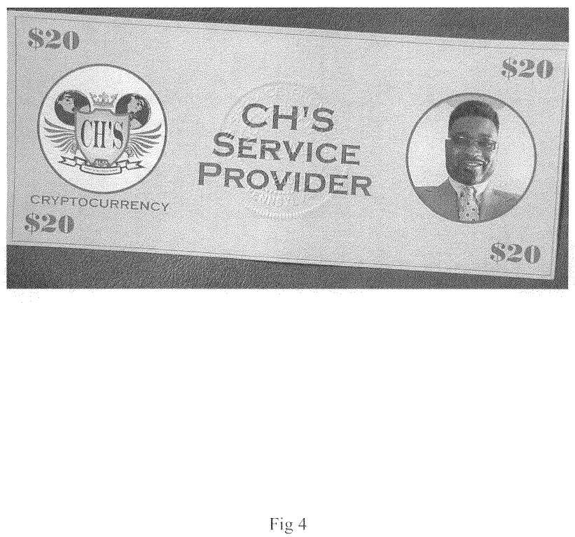

FIG. 5 illustrates another view of bill in accordance with an embodiment of the present disclosure;

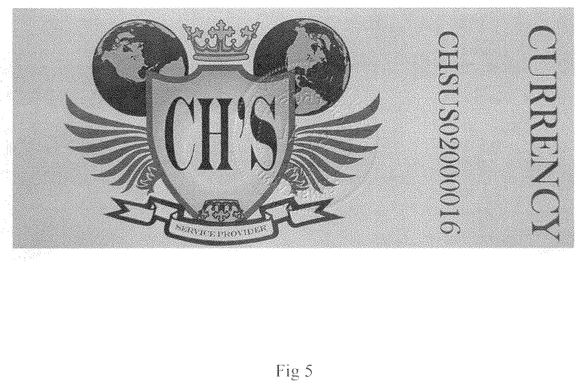

FIG. 6 illustrates a $5 bill in accordance with an embodiment of the present disclosure;

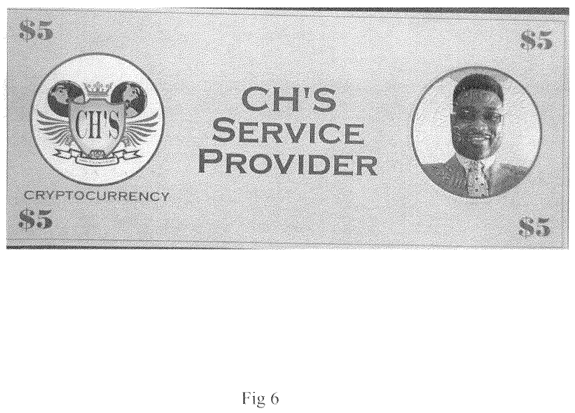

FIG. 7 illustrates multiple dollar bills in accordance with an embodiment of the present disclosure;

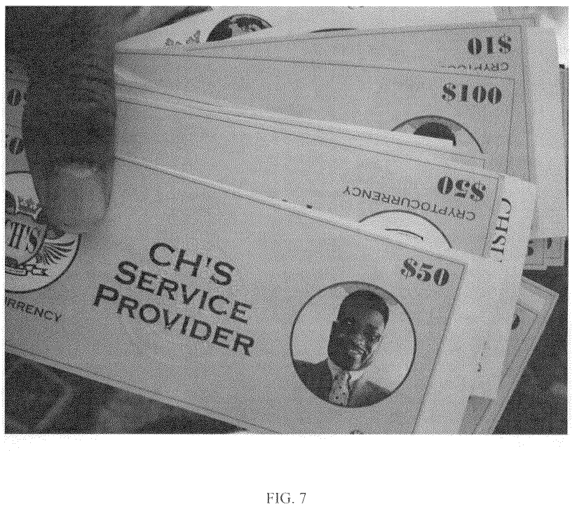

### DETAILED DESCRIPTION

For promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Aspects of the present disclosure provide a tool for managing and processing funds redistribution.

According to the systems and method provided herein, the tool for managing and processing funds redistribution in accordance with the embodiments of the invention is disclosed. A user registers and creates a profile on an application to access the tool. The user is required to complete the profile up to 100%, including making an initial payment. As the profile is completed 100%, the user receives 5-times of the initial payment as funds redistribution is processed using the computer implement tool.

The novel system as per its preferred embodiments provides a new technique of fund distribution in a block chain environment. The new market currency approach aims to help families and end poverty by 90%. The new currency market approach will be backed by donations from non-profit entities. The donation of gold deposits will be donated and supplied by international gifts to support the cause.

The system as per its further embodiments allows control of gifts by service provider's paper bills where crypto currency will seek to receive and accept international gifts by both nations and supported by M1 and M2 dollar currency. The M1 and M2 currency will be used for goods and services and will be supported by US federal reserve banks. The donation of gold will be converted into M1 and M2 currency and process into service provider saving account. The market and mutual fund account and money market deposit count with a repurchase agreement with small business quantity and time deposit would be supported by US crypto currency banking rules.

The gold donation as per its further embodiments will be converted into M1 and M2 currency and process into service provider saving account and by money market, mutual fund account and money market deposit accounts with a repurchase agreement with small nosiness quantity and time deposit will be supported by US crypto currency banking rules on saving and corporate bonds.

While specific language has been used to describe the present disclosure, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A tool for managing and processing funds redistribution, comprising:
As per claim 1, wherein the donation of gold deposits will be donated and supplied by international gifts to support the cause;
As per claim 1, wherein the system will allow control of gifts by service provider's paper bills where crypto currency will seek to receive and accept international gifts by both nations and supported by M1 and M2 dollar currency;
As per claim 1, wherein the M1 and M2 currency will be used for goods and services and will be supported by US federal reserve banks;
As per claim 1, wherein the donation of gold will be converted into M1 and M2 currency and process into service provider saving account;
As per claim 1, wherein the market and mutual fund account and money market deposit count with a repurchase agreement with small business quantity and time deposit would be supported by US crypto currency banking rules;
As per claim 1, wherein the gold donation will be converted into M1 and M2 currency and process into service provider saving account and by money market;
As per claim 1, wherein the mutual fund account and money market deposit accounts with a repurchase agreement with small nosiness quantity and time deposit will be supported by US crypto currency banking rules on saving and corporate bonds.
